(19) United States
(12) Patent Application Publication
(10) Pub. No.: US 2017/0154258 A1
(43) Pub. Date: Jun. 1, 2017

(54) JOINT ESTIMATION METHOD AND METHOD OF TRAINING SEQUENCE-TO-SEQUENCE MODEL THEREFOR

(71) Applicant: National Institute of Information and Communications Technology, Tokyo (JP)

(72) Inventors: Lemao LIU, Tokyo (JP); Andrew FINCH, Tokyo (JP); Masao UCHIYAMA, Tokyo (JP); Eiichiro SUMITA, Tokyo (JP)

(21) Appl. No.: 14/954,190

(22) Filed: Nov. 30, 2015

(51) Int. Cl. G06N 3/08

(52) U.S. Cl. CPC G06N 3/08

(57) ABSTRACT

An estimation method utilizing a pair of target-directional models 106 and 108 includes the steps 160 and 164 of decoding an input 142 utilizing the first and the second models 106 and 108, thereby producing k-best hypotheses 162 and 166 from each of the first and the second models 106 and 108; calculating a union of the k-best hypotheses, and re-scoring 168 each of the best hypotheses in the union utilizing the first and the second models; and selecting a hypothesis 144 with the highest score.

### BACKGROUND OF THE INVENTION

Field of the Invention

The present invention is related to sequence-to-sequence learning and, more particularly, it is related to sequence-to-sequence learning of Recurrent Neural Networks (RNNs) that relies on the agreement between a plurality of RNNs with different orders of the target sequence.

Description of the Background Art

RNNs are now popular tool for the so-called Artificial Intelligence. In departure from the Feed Forward Neural Networks (FFNN), RNNs have internal memories to store the history or the contexts of its internal states; therefore, RNNs are suitable to process a series of inputs that arrive in a sequence. For the basic architecture of RNNs, see Reference 9 (Mikolov et al., listed at the end of this specification), which is incorporated herein by reference.

FIG. 1 shows the structure of an RNN in a schematic diagram. Referring to FIG. 1, an RNN 30 includes: an input layer 40 for receiving an input vector 46; a hidden layer 42; and an output layer 44 for outputting an output vector 48. Each of input layer 40, hidden layer 42, and output layer 44 includes a plurality of nodes. Each of the nodes of input layer 40 has an input for receiving a corresponding element of input vector 46 and outputs connected to respective inputs of the nodes in hidden layer 42. Each node of hidden layer 42 has inputs for receiving outputs of nodes in input layer 40 and outputs connected to respective inputs of the nodes in output layer 44. Additionally, each of the nodes in hidden layer 42 has a directional loop connection 50 for feeding its output to its input. Output layer 44 has a number of nodes each has inputs connected to receive outputs of the nodes in hidden layer 42 and for outputting an element of output vector 48.

RNNs, particularly, Long Short-term Memory networks (LSTMs), provide a universal and powerful solution for various tasks that have traditionally required carefully designed, task-specific solutions. For the details of the LSTMs, see Reference 5 (Hochreiter et al) and Reference 4 (Graves 2013), which are both incorporated herein by reference. On classification tasks, they can readily summarize an unbounded context which is difficult for traditional solutions, and this leads to more reliable estimation. They have advantages over traditional solutions on a more general and challenging tasks such as sequence-to-sequence learning (See Reference 11 (Sutskever et al.), which is incorporated herein by reference), where a series of local but dependent estimations are required. RNNs make use of the contextual information for the entire source sequence and also critically are able to exploit the entire sequence of previous estimations. On various sequence-to-sequence transduction tasks, RNNs have been shown to be comparable to the state-of-the-art or superior.

FIG. 2 schematically shows the sequence of learning of typical RNNs. It is supposed in this example that the RNN including the layers 40, 42 and 44 are learning a sequence “f1 f2 f3<eos>e1 e2 e3 e4<eos>.” Here, the sequence “f1 f2 f3” is a source sequence and the symbol “<eos>” indicates the end of source sequence. The sequence “e1 e2 e3 e4” is the target sequence. The learning process is as follows: first, a pair <f1, f2> is fed to RNN. f1 is the input and the f2 is the reference. The parameter of the RNN is adjusted so that the error between the output of RNN and the reference f2 will be smaller. Next, another pair <f2, f3> is fed to the RNN. This time, f2 is the input and the f3 is the reference. In like manner, the pairs (f3, <eos>), (<eos>, e1), (e1, e2), (e2, e3) and (e3, e4) are fed to the RNN. This process is repeated for a set of training data.

In the estimating phase, RNN operates as follows. An input (f1 f2 f3 <eos>) is prepared. f1, f2 and f3 are fed to RNN in this order. At the end of the sequence, <eos>is input to the RNN. In response, an output t1 is obtained from the RNN. Next, the output t1 is fed to the RNN as a next input, and a next output t2 will appear at the output of the RNN. This process is repeated until the output sequence (t1 t2 t3 t4) is obtained. If the parameters of the RNN have been well adjusted, the output sequence (t1 t2 t3 t4) will be (e1 e2 e3 e4). This is the estimating phase of the RNN. During the estimating phase, the RNN decoder must compute a large amount of probabilities. Because the computing resources are limited and a fast response is requited, the decoder utilizes a beam search as schematically shown in FIG. 3. Referring to FIG. 3, in response to the input sequence, the decoder computes the probabilities of the possible candidates or hypotheses of the first element of output sequence. In order to reduce the computing amount, the decoder selects only a limited number of those candidates with higher probabilities (e12 in the case of FIG. 3) and further searches for the next candidate elements only for the selected candidates.

Despite their successes on sequence-to-sequence learning, RNNs suffer from a fundamental and crucial shortcoming, which has surprisingly been overlooked. When making estimations, an LSTM needs to encode the previous local estimations as a part of the contextual information. If some of previous estimations are incorrect, the context for subsequent estimations might include some noises, which undermine the quality of subsequent estimations, as shown in FIG. 4.

In FIG. 4, specifically in the estimated text 70, larger fonts indicate greater confidence in the estimated target character. The estimation at t=7 uses a context consisting of the input and all previous estimations. Since at t=5 the estimation is incorrect, i.e. it should be ‘R’ (the character 80 in the reference 72) instead of ‘L’, it leads to an incorrect estimation at t=7 (character 82). In this way, an LSTM is more likely to generate an unbalanced sequence deteriorating in quality as the target sequence is generated.

A statistical analysis on the real estimation results from an LSTM was performed in order to motivate the work reported here. The analysis supports our hypothesis, and found that on test examples longer than 10 tokens, the precision of estimations for the first two characters was higher than 77%, while for the last two characters it was only about 65%.

We conclude that this shortcoming may limit the potential of an RNN, especially for long sequences.

### SUMMARY OF THE INVENTION

Therefore, there is a need for a new framework of training sequence-to-sequence estimation model such as RNNs that will be more reliable for long sequences.

To address the above shortcoming, the present invention proposes a simple yet efficient approach. The basic idea of the embodiments of the present invention relies on the agreement between two target-specific directional LSTM models: one generates target sequences from left-to-right as usual, while the other generates target sequences in another direction, for example, from right-to-left. Specifically, we first jointly train both directional LSTM models; and then for testing (estimating), we try to search for target sequences which have support from both of the models. In this way, it is expected that the final outputs contain both good prefixes and good suffixes. Since the joint search problem has been shown to be NP-hard, its exact solution is intractable, and we have therefore developed two approximate alternatives which are simple yet efficient. Even though the proposed search techniques consider only a tiny subset of the entire search space, our empirical results show them to be almost optimal in terms of sequence-level losses.

The first aspect of the present invention is directed to a computer-implemented method of training a first sequence-to-sequence estimation model and a second sequence-to-sequence estimation model. The method includes:
a step of preparing pairs of sequences in first storage, each pair including a source sequence and a target sequence; a first step of concatenating a source sequence and a target sequence of each of the pairs of sequences stored in the first storage, thereby generating a first set of concatenated sequences and storing the first set in second storage; a first step of training the first sequence-to-sequence estimation model utilizing the first set of concatenated sequences stored in the second storage; a step of permuting a target sequence of each of the pairs of sequences by a first permuting function executed by the computer, thereby producing a permuted target sequence for each of the pairs of sequences; a second step of concatenating a source sequence of each of the pairs of sequences and the permuted target sequence paired with the source sequence, thereby generating a second set of concatenated sequences and storing the second set in third storage; and a second step of training the second sequence-to-sequence estimation model utilizing the second set of concatenated sequences stored in the third storage.

Preferably, the permuting function is a function reversing the order of tokens in an input sequence.

More preferably, each of the first and the second sequence-to-sequence estimation models are RNNs.

The second aspect of the present invention is directed to a computer-implemented joint estimation method utilizing the first and the second sequence-to-sequence estimation models trained by the method described above. The method includes the steps of: receiving an input sequence as an input of the computer; decoding the input utilizing the first and the second sequence-to-sequence estimation models, thereby producing a prescribed number of best hypotheses from each of the first and the second sequence-to-sequence models; permuting tokens by a second permuting function executed by the computer, in each of the prescribed number of best hypotheses output from the second sequence-to-sequence estimation model; re-scoring each of the best hypotheses output from the first sequence-to-sequence estimation model and the best hypothesis with tokens permuted in the permuting step utilizing the first and the second sequence-to-sequence estimation models; and selecting a hypothesis with the highest score in the re-scoring step as an estimated output corresponding to the input.

Preferably, the second permuting function is an inverse of the first permuting function.

More preferably, the permuting function is a function reversing the order of tokens in an input sequence.

Further preferably, each of the first and the second sequence-to-sequence estimation models are RNNs.

The re-scoring step may include the steps of: calculating a union set of the best hypotheses output from the first sequence-to-sequence estimation model and the best hypotheses output from the second sequence-to-sequence estimation model with tokens permuted in the permuting step; computing a first score of each of the hypotheses in the union set utilizing the first sequence-to-sequence estimation model; computing a second score of each of the hypotheses in the union set utilizing the second sequence-to-sequence estimation model; and re-scoring each of the hypotheses in the union set by multiplying the first score by the second score.

Preferably, the re-scoring step may include the steps of: calculating a union set of the best hypotheses output from the first sequence-to-sequence estimation model and the best hypotheses output from the second sequence-to-sequence estimation model with tokens permuted in the permuting step; generating a set of new hypotheses by concatenating any one of prefixes in the hypotheses in the union set and any one of suffixes in the hypotheses in the union set; computing a first score of each of the new hypotheses utilizing the first sequence-to-sequence estimation model; computing a second score of each of the new hypotheses utilizing the second sequence-to-sequence estimation model; and re-scoring each of the new hypotheses by multiplying the first score by the second score.

The third aspect of the present invention is directed to a computer-implemented joint estimation apparatus utilizing the first and the second sequence-to-sequence estimation models trained by the method described above. The apparatus includes: a data receiving interface connected to the computer, configured to receive an input sequence as an input; a storage device connected to the computer, for storing the first and the second sequence-to-sequence estimation models; and a control unit. The control unit is configured to; decode the input utilizing the first and the second sequence-to-sequence estimation models, thereby producing a prescribed number of best hypotheses from each of the first and the second sequence-to-sequence models; permute tokens by executing a second permuting function, in each of the prescribed number of best hypotheses output from the second sequence-to-sequence estimation model; re-score each of the best hypotheses output from the first sequence-to-sequence estimation model and the best hypothesis with tokens permuted in the permuting step utilizing the first and the second sequence-to-sequence estimation models; and select a hypothesis with the highest score in the re-scoring step as an estimated output corresponding to the input.

The second permuting function may be an inverse of the first permuting function.

Preferably, the permuting function is a function reversing the order of tokens in an input sequence.

More preferably, each of the first and the second sequence-to-sequence estimation models are RNNs.

Further preferably, in re-scoring, the control unit is configured to: calculate a union set of the best hypotheses output from the first sequence-to-sequence estimation model and the best hypotheses output from the second sequence-to-sequence estimation model with tokens permuted; compute a first score of each of the hypotheses in the union set utilizing the first sequence-to-sequence estimation model; compute a second score of each of the hypotheses in the union set utilizing the second sequence-to-sequence estimation model; and re-score each of the hypotheses in the union set by multiplying the first score by the second score.

Preferably, in rescoring, the control unit is configured to calculate a union set of the best hypotheses output from the first sequence-to-sequence estimation model and the best hypotheses output from the second sequence-to-sequence estimation model with tokens permuted; generate a set of new hypotheses by concatenating any one of prefixes in the hypotheses in the union set and any one of suffixes in the hypotheses in the union set; compute a first score of each of the new hypotheses utilizing the first sequence-to-sequence estimation model; compute a second score of each of the new hypotheses utilizing the second sequence-to-sequence estimation model; and re-score each of the new hypotheses by multiplying the first score by the second score.

The present invention makes the following contributions: It proposes an efficient approximation of the joint search problem, and demonstrates empirically that it can achieve close to optimal performance. This approach is general enough to be applied to any deep recurrent neural networks.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the architecture of an RNN.

FIG. 2 shows the learning and estimating schemes of an RNN.

FIG. 3 is a conceptual diagram explaining a beam search.

FIG. 4 shows an example caused by the prior art sequence-to-sequence learning.

FIG. 5 shows the overall structure of bidirectional learner of an embodiment of the present invention.

FIG. 6 is a block diagram of joint search apparatus shown in FIG. 5.

FIG. 7 shows a re-scorer of the first embodiment in a block diagram.

FIG. 8 shows a re-scorer of the second embodiment in a block diagram.

FIG. 9 shows the schematic flowcharts of the programs for implementing generalized version of the learner and estimator of the present invention.

FIGS. 10 and 11 show the result of experiments.

FIG. 12 shows a computer system used for implementation of the embodiments of the present invention.

FIG. 13 is a hardware block diagram of the computer system shown in FIG. 12.

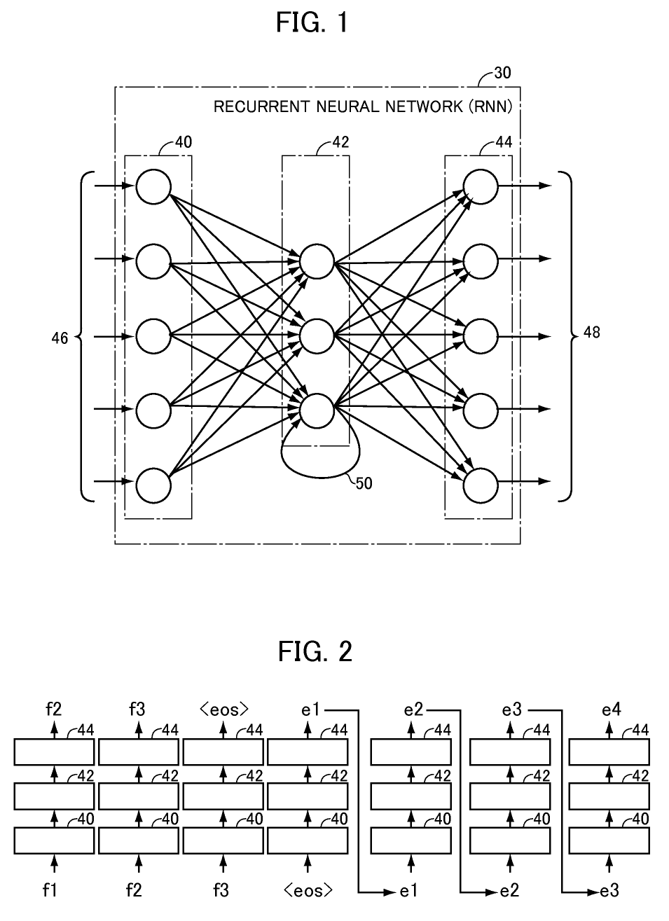

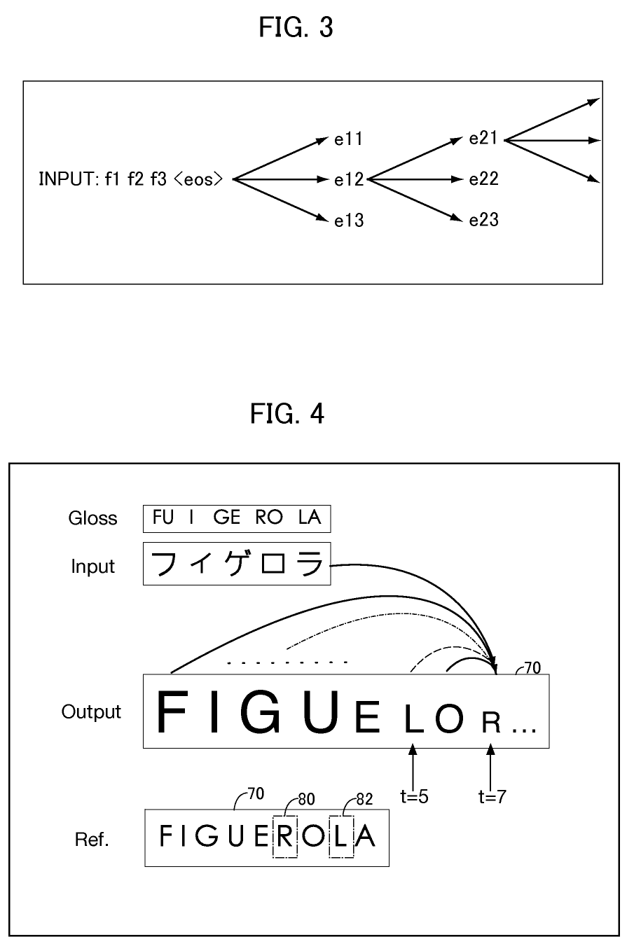

### DESCRIPTION OF THE PREFERRED EMBODIMENTS

In the following, the same components are denoted by the same reference numerals. Their names and functions are the same; therefore, their detailed description will not be repeated.

Although the following embodiments are directed to machine transliteration and grapheme-to-phoneme tasks for reasons of simplicity, the present invention has the potential to be applied to any sequence-to-sequence learning tasks including machine translation, in which the generation of long sequences is a challenging task.

### Revisiting the Generic LSTM

Suppose x denotes a general (either source or target) sequence of tokens (characters in this case), its t^{th} character (character at time step t) is xₜ and its length is |x|. In particular, a source sequence is denoted by f while a target sequence is denoted by e. θ denotes the overall model parameters of recurrent neural networks: θ^{superscript} denotes a component parameters of θ depending on superscript, and it is either a bias vector (if superscript includes character b) or a matrix; θ(xₜ) is a vector representing the word embedding of xₜ, which is either a source character or a target character; I(θ, xₜ) denotes the index of word xₜ in the source or target vocabulary specified by x. Note that in the rest of this paper, the subscript is reserved as the time step in a sequence for easier reading.

### Model Definition

The sequence-to-sequence learning model by RNN is defined as follows (Reference 4):

$$\begin{matrix}P ( e \vert f ; θ ) = {\prod }_{t}^{ } P ( {e}_{t} \vert {h}_{t} ( e ) ; θ ) \\ = {\prod }_{t}^{ } g ( {θ}^{1} p ( {h}_{t} ( e ) ) ) [ I ( θ , {e}_{t} ) ]\end{matrix}$$

where g is a softmax function, p is an operator over a vector dependent on specific instances of RNNs, [•] denotes the subscript operator of a vector and a vector hₜ(x) is the recurrent hidden state of sequence x at time step t with base cases: h₋₁(f)=0 and ₕ₋₁(e)=h_{|f|-1}(f).

### Decoding

Given a source sequence f and parameters θ, decoding can be formulated as follows:

$$\hat{e} = ( f ; θ , Ω ( f ) ) = {arg max}_{e ∈ Ω ( f )} P ( e \vert f ; θ ) \qquad ( 2 )$$

where P is given by Equation (1), and Ω(f) is the set of all possible target sequences f that can be generated using the target vocabulary. Since the prediction at time step t (i.e. eₜ) is dependent on all the previous estimations, it is NP-hard to optimize the exact solution of Equation (2). Instead, an approximate solution, beam search, is widely applied (Reference 11 (Sutskever et al., 2014). It generates the target sequence from left-to-right, that is, it generates targets from the beginning t=0 to the end (at which point a special sequence termination symbol is generated). During the search, at each t, a set of top-k partial hypotheses (i.e. prefixes) is maintained in a priority queue, and only these hypotheses will be extended. The priority queue ordered with respect to the model scores of a partial hypothesis. The search process for sequence-to-sequence transduction using LSTM RNNs usually employs a small beam size (a typical beam size being 12), which has been shown empirically to be sufficient for high quality results (Reference 11 (Sutskever et al., 2014)).

Recently, it has been shown that substantial gains in performance can be obtained when using an ensemble of multiple LSTMs, and therefore the following embodiments have adopted this approach for the experiments given somewhere in this specification. Decoding with an ensemble model is similar to that of a single LSTM except the ensemble's model scores are defined to be the sum of individual models' scores. This sum can be efficiently calculated during the search process.

### Fundamental Shortcoming of Conventional LSTMs

Despite their successes on various tasks, RNNs still suffer from a fundamental shortcoming. Suppose at time step t when estimating eₜ, there is an incorrect estimation eₜ, for t′ with 0≦t′≧t. In other words, the hidden states hₜ, encode this incorrect information for each t″ in the range t′≦t″≦t; and this can be expected to degrade the quality of all the estimations made using the noisy hₜ. Ideally, if the probability of a correct estimation at t″ is p_{t″}, then will hₜ contain noisy information with a probability of; 1−Π_{0≦t′<t}P_{t′}. As t increases the probability of noise in the context increases quickly, and therefore it is more difficult for an RNN to make correct estimations as the sequence length increases. As a result, generic LSTMs cannot maintain the quality of their earlier estimations in their later estimations as has been explained with reference to FIG. 4, and this is a serious problem especially when the input sequence is long.

In the subsequent sections, we will present the description of embodiments to overcome this shortcoming in detail.

### Agreement on Target-Bidirectional LSTMs

As explained in the previous section, although the generic (left-to-right) LSTM struggles when estimating suffixes, fortunately, it is very capable at estimating prefixes. By contrast, a complementary LSTM which generates targets from right-to-left, is proficient at estimating suffixes. Inspired by work in the field of word alignment (Reference 8 (Liang et al. 2006)), we propose an agreement model for sequence-to-sequence learning. It encourages the agreement between both target-directional LSTM models.

Formally, we develop the following joint target-bidirectional LSTM model:

Pⱼₙₜ(e|f;\vec{θ}, [symbol] )=\vec{P}(e|f;\vec{θ})× [symbol] (e|f; [symbol] ) (3)

where P and [symbol] are the left-to-right and right-to-left LSTM models respectively, with definitions similar to Equation (1); \vec{θ} and [symbol] denote their parameters. This model is called an agreement model or joint model in this specification, and [symbol] = [symbol] \vec{θ}, [symbol] [symbol] denotes its parameters for simplicity. The training can be written as the minimization of the following equation:

$${min}_{\overleftrightarrow{θ}} {\sum }_{〈 f , e 〉}^{ } log ( {P}_{jnt} ( e \vert f ; \overleftrightarrow{θ} ) ) \qquad ( 4 )$$

where the example [symbol] f, e [symbol] ranges over a given training set. To perform the optimization, we employ AdaDelta (Reference 12 (Zeiler 2012)), a mini-batch stochastic gradient method. The gradient is calculated using back-propagation through time (Reference 10 (Rumelhart et al., 1986), which is incorporated by reference), where the time is unlimited in the experiments described later. We employ the MAP strategy for testing.

In summary, the training of the bidirectional model encourages the agreement of two unidirectional models by minimizing a joint objective function. Then, for each test sequence, a joint search is performed to find the target sequence with the highest score from the agreement model. In the next section we will introduce the proposed methods for the joint search.

### Approximations of Joint Search

In this section we will first analyze the question of how to search for the best hypothesis during the testing of our bidirectional model, and then propose two possible solutions. The first embodiment is directed to the first solution, and the second embodiment is directed to the second.

### Challenges in Joint Search

The exact inference for an agreement model is usually intractable, even in the cases where the individual models can be factorized locally. In order to address this, on an agreement task using HMMs, Reference 8 (Liang et al. 2006) applies an approximate inference method which depends on the tractable calculation of the marginal probability of each local estimation according to the individual models. Unfortunately, this approximate method cannot be used in our case, because our individual model (the LSTM) is globally dependent and therefore such marginal calculations are not possible (tractable).

The beam search method, used for generic LSTMs mentioned before, is also impracticable. The reason being that the generation processes proceed in different directions; the joint model generates partial sequences either in a left-to-right or in a right-to-left manner during the search. It is impossible to calculate both left-to-right and right-to-left model scores simultaneously for each partial sequence.

We propose two simple approximate methods for joint search, which explore a smaller space than that of beam search. Their basic idea is aggressive pruning followed by exhaustive search: we first aggressively prune the entire exponential search space and then obtain the 1-best result via exhaustive search over the pruned space with respect to the agreement model. Critical to the success of this approach is that the aggressive pruning must not eliminate the promising hypothesis from the search space prior to the exhaustive search phase.

k-best Approximation

Suppose L₁₂ᵣ and Lᵣ₂ₗ are two top-k target sequence sets from the generic left-to-right and right-to-left LSTM models, respectively. Then we construct the first search space S₁ as the union of these two sets:

S₁=Lₗ₂ᵣ∪Lᵣ₂ₗ

In this way, exhaustively rescoring S₁ with the agreement model has complexity O(k). One advantage of this method is that the search space is at most twice the size of that of its component LSTM models, and since the k-best size for generic LSTMs is typically very small, this method is computationally light. To make this explicit, in all the experiments reported here, the k-best size was 12, and the additional rescoring time was negligible.

### Polynomial Approximation

Observing that both the prefixes of sequences in Lₗ₂ᵣ and the suffixes of sequences in Lᵣ₂ₗ are of high quality, we construct the second search space S₂ as follows:

S₂={e[:t]∘e′[t′:]e∈Lₗ₂ᵣe′∈Lᵣ₂ₗ, 0≦t≦|e|, 0≦t′≦|e′|}

where ∘ is a string concatenation operator, [: t] is a prefix operator that yields the first t tokens (characters) of a string, and [t :] is a suffix operator that yields the last t tokens (characters). Exhaustively rescoring over this space has complexity O(k²N²), where N is the length of the longest target sequence. In our implementation, the speed for rescoring over this space was approximately 0.1 seconds per sentence, thanks to efficient use of a GPU. We can see that the search space of this method includes that of the first method as a proper subset (S₂⊃S₁), and thus this method can be expected to lead to higher 1-best agreement model scores than the previous method.

### First Embodiment

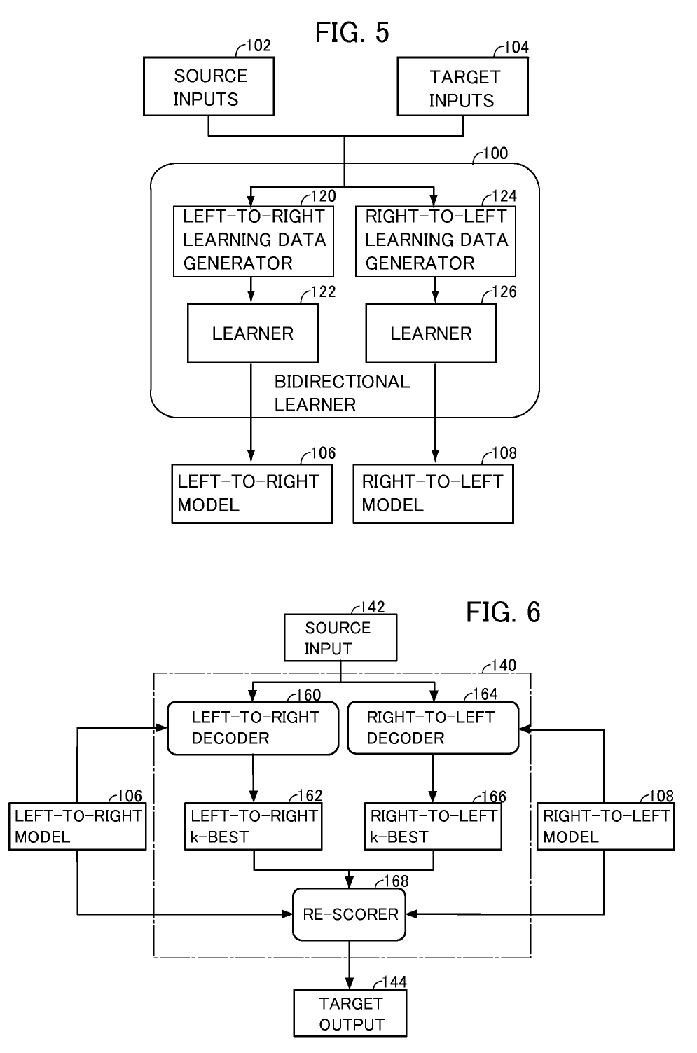

Referring to FIG. 5, a bidirectional learner 100 of the first embodiment of the present invention trains a left-to-right model 106 and right-to-left model 108, each of which is an LSTM using the source inputs 102 and target inputs 104. Each of the source sequences in source inputs 102 has a counterpart target sequences in target inputs 104. Each of these sequences has a <eos> symbol, which indicates the end of a sequence, appended at their ends.

Bidirectional learner 10 includes a left-to-right learning data generator 120 for generating a left-to-right learning sequences by concatenating each of the source sequences and its counterpart target sequences, a learner 122 for training left-to-right model 106 in the manner as described above with reference to FIG. 2. Bidirectional learner 100 further includes: a right-to-left learning data generator 124 for generating a right-to-left learning sequences by first inverting the order of each of the target inputs from left-to-right to right-to-left and then concatenating each source input and its counterpart inverted target input and a learner 126 for training right-to-left model 10 utilizing the data generated by right-to-left learning data generator 124. After learning is complete, left-to-right model 106 and right-to-left model 108 can be used to estimate a target sequence in response to an input of a source sequence by a joint search apparatus as shown in FIG. 6.

FIG. 6 schematically shows the structure of the joint search apparatus 140 for estimating target output 144 in response to a source input 142. In estimation, joint search apparatus 140 utilizes left-to-right model 106 and right-to-left model 108.

Joint search apparatus 140 includes: a left-to-right-decoder 160 for decoding source input 142 utilizing left-to-right model 106 and for outputting left-to-right k-best 162 with respective decoding scores; a right-to-left decoder 164 for decoding source input 142 utilizing right-to-left model 108 and for outputting right-to-left k-best 166 with respective decoding scores; and a re-scorer 168 for rescoring each hypothesis in the union of left-to-right k-best 162 and right-to-left k-best 166 by multiplying the respective scores of the hypotheses. The 1-best of the result of rescoring of re-scorer 168 is output as target output 144.

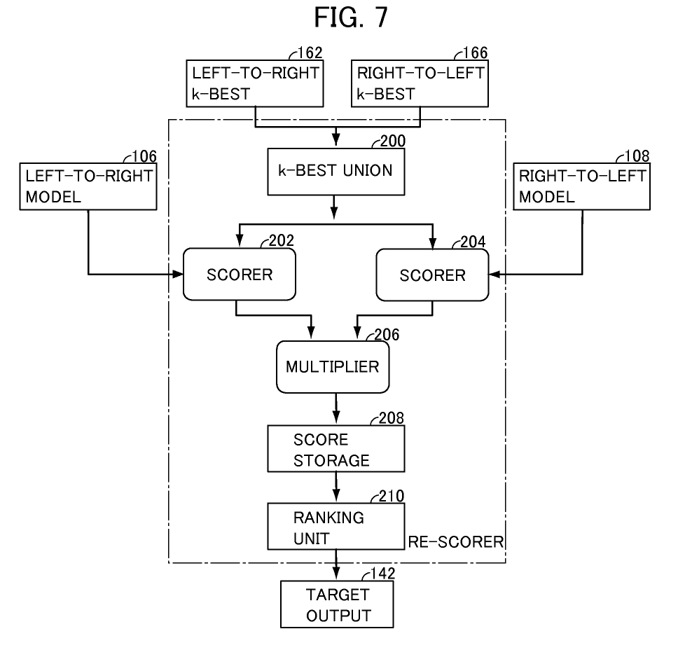

Referring to FIG. 7, re-scorer 168 includes: a union calculator 200 for calculating a union of left-to-right k-best 162 and right-to-left k-best 166; a left-to-right scorer 202 for scoring each of the k-best utilizing left-to-right model 106; a right-to-left scorer 204 for scoring each of the k-best utilizing right-to-left model 108; a multiplier 206 connected to receive the scores calculated by scorers 202 and 204 for multiplying one score with the other; score storage 208 for storing the scores for the k-best in the k-best union; and a ranking unit 210 for ranking the k-best with their scores and for outputting the hypothesis with the highest score as target output 144.

Bidirectional learner 100 and joint search apparatus 140 operates as follows.

Referring to FIG. 5, in the training phase, source inputs 102 and target inputs 104 are prepared. Left-to-right learning data generator 120 concatenates each of source inputs 102 with counterpart target inputs 104 and feed it to learner 122. Learner 122 trains left-to-right model 106 in the manner as described with reference to FIG. 2. Right-to-left learning data generator 124 inverts the tokens in each of target inputs 104, and then concatenates each of source inputs 102 and corresponding one of inverted target inputs 104. Right-to-left learning data generator 124 then feeds the concatenated sequences to learner 126. learner 126 trains right-to-left model 108. When all of the source inputs 102 and target inputs 104 are used to train left-to-right model 106 and right-to-left model 108, joint search apparatus 140 can be operable.

Referring to FIG. 6, in the operating (estimating) phase, joint search apparatus 140 is connected to left-to-right model 106 and right-to-left model 108. More specifically, left-to-right model 106 is connected to left-to-right-decoder 160 and re-scorer 168, and right-to-left model 108 is connected to right-to-left decoder 164 and re-scorer 168.

When source input 142 is input to joint search apparatus 140, left-to-right-decoder 160 decodes the input utilizing left-to-right model 106 and outputs the left-to-right k-best 162. Right-to-left decoder 164 decodes the input and outputs right-to-left k-best 166.

Referring to FIG. 7, union calculator 200 of re-scorer 168 receives left-to-right k-best 162 and right-to-left k-best 166, and calculates their union 200. For each of the k-best in the k-best union, scorer 202 calculates the left-to-right score utilizing left-to-right model 106, and right-to-left scorer 204 calculates right-to-left score utilizing right-to-left model 108. multiplier 206 multiplies one of the scores by the other. Score storage 208 stores the scores calculated by multiplier 206 with associated hypotheses. Ranking unit 210 finds the hypothesis that has the highest score and output it as target output 144.

### Second Embodiment

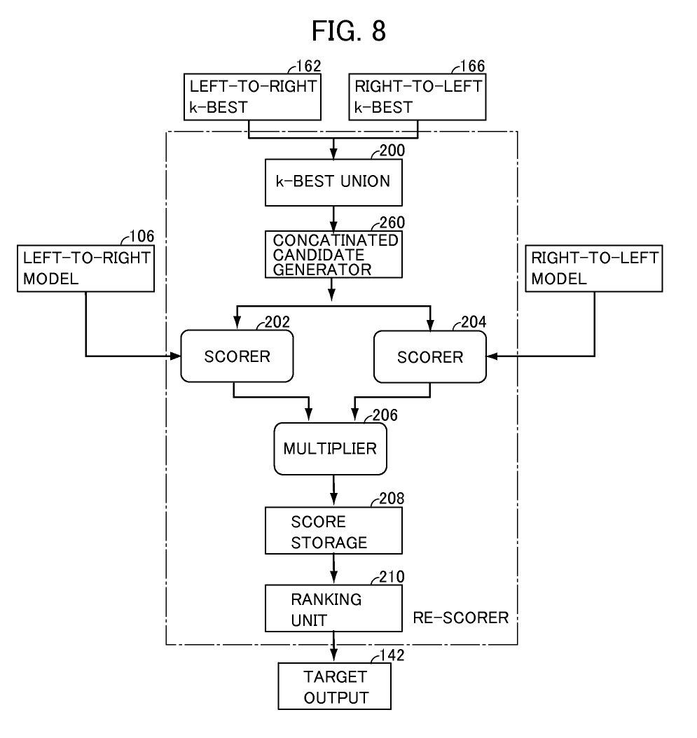

The second embodiment is directed to the polynomial approximation. Referring to FIG. 8, re-scorer 240 of the present embodiment can replace re-scorer 168 of the first embodiment shown in FIG. 7. Re-scorer 240 includes, in addition to the components of re-scorer 168 shown in FIG. 7, a concatenated candidate generator 260 for concatenating all possible combinations of prefixes and suffixes found in the k-best union, thereby creating a search space larger than that of the first embodiment. The output of concatenated candidate generator 260 is applied to scorer 202 and 204.

In this embodiment, the search space is substantially larger than that of the first embodiment; still, however, it is sufficiently small and the required computing amount is reasonably small.

### Third Embodiment

The first embodiment and the second embodiment are directed to joint estimation using left-to-right and right-to-left models. The present invention is not limited to such embodiments. The right-to-left model may be replaced with any model that is trained with the permuted target sequence as long as the permutation G(x) has an inverse permutation H(x) such that e=H(G(e)). The third embodiment is directed to such a generalized version of the first and the second embodiments. Note that the permutation function may be different depending on the number of tokens in a sequence.

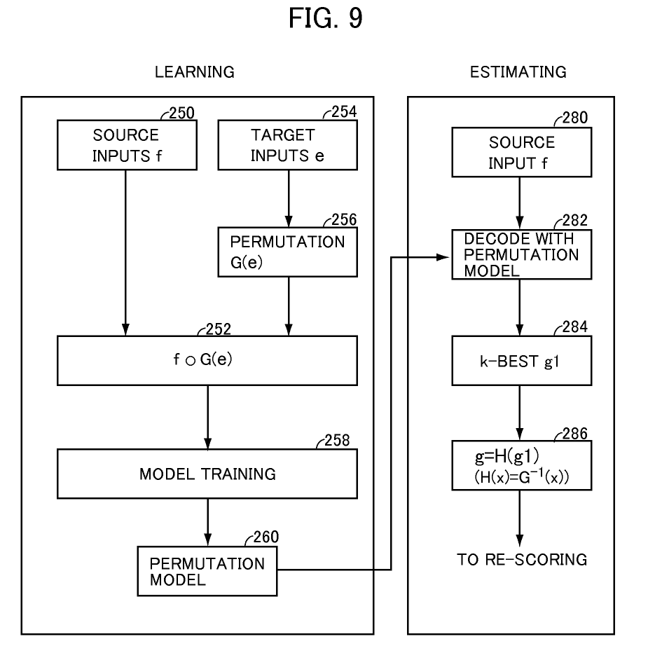

Referring to FIG. 9, in the learning step, source inputs f 250 and target inputs e are stored in a storage device not shown. A source input f and target input e make a pair. For each pair, target input e is subjected to a permutation step 256 where target input s is permutated by the permutation function G(e). Next, at the concatenation step 252, source input f and the permuted target input G(e) is concatenated. By the steps 252 and 256, a concatenated bilingual sequence for training are prepared. The concatenated bilingual sequences are used in step 258 for training a permutation model 260.

The process at step 258 can be written in a pseudo code as follows:

while not convergence
pick up a mini-batch from concatenated bilingual sequences
calculate the gradient of joint objective function over the mini-batch
update model parameters by a gradient descent algorithm

return model parameters

The gradient descent algorithm may be AdaGrad, for example.

With reference to the right side of FIG. 9, in the estimating phase, a source input 280 (source input f) is fed into the joint search apparatus. A decoder (not shown) decodes the source input f utilizing the permutation model 260 at step 282, thereby outputting k-best 284. Because the outputs of step 282 are sequences permuted by permutation function G(x), each of the k-best candidates g1 are subjected to the function H(x). The outcomes g of the function H(x) are the candidates in an ordinary order and are fed into the re-scoring unit (not shown).

The above-described embodiments 1 and 2 are the particular cases of this third embodiment.

### Experiments

### Experimental Methodology

We evaluated our approach on machine transliteration and grapheme-to-phoneme conversion tasks. For the machine transliteration task, we conducted both Japanese-to-English and English-to-Japanese directional subtasks. The transliteration training, development and test sets were taken from Wikipedia inter-language link titles: the training data consisted of 59000 sequence pairs composed of 313378 Japanese katakana characters and 445254 English characters; the development and test data were manually cleaned and each of them consisted of 1000 sequence pairs. For grapheme-to-phoneme conversion, the training set was the CMU dictionary consisting of about 110000 sequence pairs. We split the available test set consisting of 12374 sequence pairs into two equal-sized parts: the first part was used as the development set and the other was used as the test set. We use both ACC (sequence level) and FSCORE (non-sequence level) as the evaluation metrics.

Six baseline systems were used and are listed below. The first four used open source implementations, and the last two were re-implemented:
1. Moses: a phrase-based statistical machine translation system proposed in Reference 7 (Koehn et al. 2007) used with default settings except the decoding process was forced to be monotonic, as in Reference 3 (Finch and Sumita 2008); the reported results are the best from five independent runs of MERT to alleviate the negative effects from randomness.
2. DirecTL+: a feature-rich linear model trained and run with default settings as in Reference 6 (Jiampojamarn et al., 2008).
3. Sequitur G2P: a joint n-gram model trained and run with default settings proposed in Reference 2 (Bisani et al., 2008).
4. NMT: a neural translation model proposed in Reference 1(Bandanau et al., 2014) trained and run with default settings except that the word embedding dimension was set to 500. This value was chosen because it decreased run times with no apparent effect on system performance.
5. GLSTM: a single generic LSTM and that was re-implemented following Reference 11 (Sutskever et al., 2014).
6. ELSTM: an ensemble of several GLSTMs with the same direction.
   Our proposed bidirectional (agreement) LSTM models are denoted:
1. BLSTM: a single left-to-right (l2r) LSTM and a single right-to-left (r2l) LSTM.
2. BELSTM: ensembles of LSTMs in both directions.

In addition we use the following notation: nl2r or nr2l denotes the number of left-to-right or right-to-left LSTMs in the ensembles of the ELSTM and BELSTM. For example, BELSTM (5l2r+5r2l) denotes ensembles of five l2r and five r2l LSTMs in the BELSTM.

For fair comparison, the stopping iteration for all systems was selected using the development set for all systems except Moses (which has its own termination criteria). For all of the re-implemented models, the number of word embedding units and hidden units were set to 500 to match the configuration using in the NTM.

### Evaluation of the Joint Search Strategies

Suppose the parameters of our agreement model [symbol] are fixed after training, e is the reference sequence of f, S denotes the search space (either S₁ or S₂) of our approximate methods, and ê(f; [symbol] ,Ω), defined as in Equation (2), is the best target sequence of f in the search space Ω∈{S₁, S₂Ω(f)}.

If Pⱼₙₜ(e|f; [symbol] )==Pⱼₙₜ(ê(f; [symbol] , S)|f; [symbol] ), then our approximate search has resulted in the reference, as desired. Otherwise, we have the following possible outcomes:
GT:
   If Pⱼₙₜ(e|; [symbol] )>Pⱼₙₜ(ê(f; [symbol] ,S)|f; [symbol] ), our approximate search is insufficient, since Pⱼₙₜ(e|f; [symbol] ) might be equal to Pⱼₙₜ(ê(f; [symbol] ,Ω(f))|f; [symbol] ), which is the upper bound of Pⱼₙₜ(ê(f; [symbol] ,S)|f; [symbol] ) and the globally optimal probability. Therefore, this case is concerned with search errors.

ST:
If Pⱼₙₜ(e|f; [symbol] )<Pⱼₙₜ(ê(f; [symbol] ,S)|f; [symbol] ), then Pⱼₙₜ(e|f; [symbol] ) is definitely less than Pⱼₙₜ(ê(f; [symbol] ,Ω(f))|f; [symbol] ). In other words, even if we have the optimal joint search method, it still cannot find the correct sequence as the reference. The quality of the model rather than the search is the issue in this case.

Using this as a basis, we designed a scheme to evaluate the potential of our search methods as follows: we randomly select examples from the development set and compare the model scores of the references and the 1-best results from the approximate search methods; then analyze the distributions of the two cases GT and LT, where our model fails. In addition, to alleviate the dependency on [symbol] , we tried 100 parameter sets optimized by our training algorithm starting from different initializations.

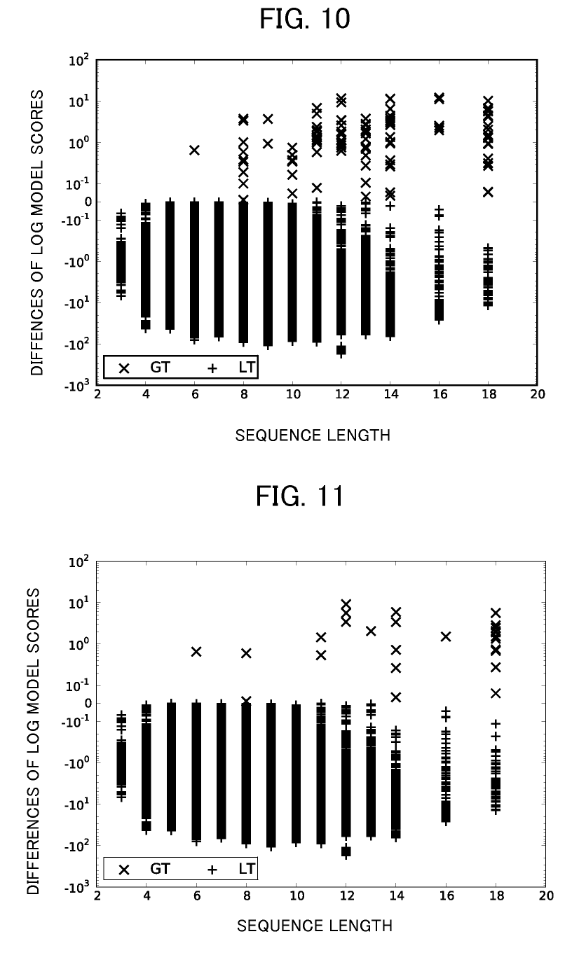

FIG. 10 and FIG. 11 show that the distribution of GT and LT with respect to source sequence length for both approximate search methods. It is clear that k-best approximation suffers from some search errors shown on the graph as GT (a ‘x’), many of which were eliminated by using polynomial approximation method. Fortunately, the cases of LT (plotted with a ‘+’) far outnumber the GT cases, and only 0.2% of all cases were GT, even for k-best approximation. This 0.2% represents all that is possible to be gained by improving the search technique, and therefore both approximate methods can be said to be “almost optimal”. The above scheme relates to sequence-level losses like ACC, but it cannot give an indication of the effect on non sequence-level losses. Empirically however, our approximate search methods appeared to be effective when performance was measured using non-sequence-level losses (FSCORE). The reason may be that non-sequence-level losses are usually positively correlated to sequence-level losses.

### Main Results

TABLE 1

| Approximations | Acc | Fscore |
|---|---|---|
| k-best | 33.3 | 85.1 |
| polynomial | 33.4 | 85.1 |

Table 1 shows the comparison between the approximate search methods on the JP-EN test set. We can see that they perform almost identically in terms of ACC and FSCORE. This result is not surprising, because both of them are near optimal (as illustrated in the previous section). Therefore, in the remainder of the experiments, we only report the results using the k-best approximate search.

TABLE 2

| | | JP-EN | | EN-JP | | GM-PM | | avg | |
|---|---|---|---|---|---|---|---|---|---|
| Systems | Model | ACC | FSCORE | ACC | FSCORE | ACC | FSCORE | ACC | FSCORE |
| Moses | Log-linear | 29.8 | 83.3 | 37.1 | 80.8 | 69.0 | 93.0 | 45.3 | 85.7 |
| DirecTL + | feature-rich linear | 11.1 | 75.1 | 31.7 | 79.9 | 67.0 | 91.9 | 36.6 | 82.3 |
| equitur G2 | joint n-gram | 34.6 | 84.6 | 39.8 | 81.6 | 75.3 | 94.2 | 46.6 | 85.4 |
| NMT | Neural Network | 29.2 | 82.8 | 40.0 | 81.2 | 70.6 | 92.1 | 46.6 | 85.4 |
| GLSTM | (l2r)LSTM | 28.3 | 83.0 | 40.1 | 81.0 | 70.4 | 92.0 | 46.3 | 85.3 |
| BLSTM | (l2r + r2l)LSTMs | 33.3 | 185.1 | 43.8 | 85.0 | 76.2 | 94.2 | 51.1 | 88.1 |
| ELSTM | 5LSTMs | 34.2 | 85.4 | 44.5 | 86.0 | 77.6 | 94.6 | 52.1 | 88.7 |
| BELSTM | (5l2r + 5r2l)LSTMs | 36.3 | 86.0 | 45.3 | 86.3 | 78.7 | 95.0 | 53.4 | 89.1 |

Table 2 shows the results on the test sets of all three tasks:

JP-EN,EN-JP and GM-PM. Firstly, we can see that the undirectional neural networks (NMT and GLSTM) have lower performance than the strongest non-neural network baselines (Sequitur G2P), even when they achieve comparable performance on EN-JP. Our agreement model BLSTM shows substantial gains over both the GLSTM and NMT on all three tasks.

More specifically, the gain was up to 5.8 percentage points in terms of ACC and up to 2.2 percentage points in terms of FSCORE. Moreover, BLSTM showed comparable performance relative to Sequitur G2P on both JP-EN and GM-PM, and was markedly better on the EN-JP task.

Secondly, the BELSTM which used ensembles of five LSTMs in both directions consistently achieved the best performance on all the three tasks, and outperformed Sequitur G2P by up to 5.5 points in ACC and 4.7 points in FSCORE. To the best of our knowledge, this method has achieved a new state-of-the-art performance on GM-PM. In addition, BELSTM outperformed the ELSTM by a substantial margin on all tasks, showing that our bidirectional agreement is effective in improving the performance of the unidirectional ELSTM on which it is based.

Furthermore it is clear that the gains of the BELSTM relative to the ELSTM on JP-EN were larger than those on both EN-JP and GM-PM. We believe the explanation is likely to be that the relative length of target sequences with respect to the source sequences on JP-EN is much larger than those on EN-JP and GM-PM, and our agreement model is able to draw greater advantage from the relatively longer target sequences. The relative length of the target for JP-EN was 1.43, whereas the relative lengths for EN-JP and GM-PM were only 0.70 and 0.85, respectively.

### Analysis on JP-EN

TABLE 3

| Systems | Prefix | Suffix |
|---|---|---|
| GLSTM(l2r) | 77% | 65% |
| GLSTM(r2l) | 76% | 74% |
| BLSTM | 80% | 74% |
| ELSTM(5l2r) | 82% | 73% |
| ELSTM(5r2l) | 82% | 77% |
| BELSTM | 82% | 78% |

One of the main weaknesses of RNNs is their unbalanced outputs which have high quality prefixes but low quality suffixes, as discussed earlier. Table 3 shows that the difference in precision is 12% for GLSTM (l2r) between prefixes and suffixes. This gap narrowed using the BLSTM, which out-performed the GLSTM (l2r) on both prefix and suffix (with the largest difference on the suffix) and outperformed the GLSTM (r2l) on the prefix. A similar effect was observed with the BELSTM, which generated the better, more balanced outputs compared to ELSTM(5l2r) and ELSTM(5r2l) models.

TABLE 4

| Systems | ACC | FSCORE |
|---|---|---|
| GLSTM(l2r) | 17.3% | 82.2% |
| GLSTM(r2l) | 18.5% | 83.5% |
| BLSTM | 25.0% | 85.3% |
| ELSTM(5l2r) | 24.4% | 86.8% |
| ELSTM(5r2l) | 28.6% | 87.0% |
| BELSTM | 28.6% | 88.2% |

Our agreement model worked well for long sequences, and this is shown in Table 4. The BLSTM obtained large gains over GLSTM(l2r) and GLSTM(r2l), (the gains were up to 7.7 and 3.1 in terms of ACC and FSCORE, respectively). Furthermore, the BELSTM obtained gains of 1.2 points in terms of FSCORE over the ELSTM(5r2l), but gave no improvements in terms of ACC. This is to be expected, since for long sequences it is hard to generate targets that exactly match the references and thus it is more difficult to improve ACC.

Even though our agreement model can be applied on top of an ensemble, we compare them in order to put the advantage of our model in perspective. To ensure a fair comparison, the number of individual LSTMs in both the ensemble and our agreement model were identical in the experiments. As shown in Table 5, although the BLSTM(r2l+l2r) explores a much smaller search space than the ELSTM(2r2l), it substantially outperformed it. As the number of total number of LSTMs used was increased to ten, the BELSTM(5l2r+5r2l) still obtained substantial gains over the ELSTM(10l2r). Incorporating more directional LSTMs in the BELSTM(10l2r+10r2l) further increased the performance of the BELSTM.

TABLE 5

| Systems | ACC | FSCORE |
|---|---|---|
| GLSTM(l2r) | 28.3% | 83.4% |
| GLSTM(r2l) | 29.7% | 83.6% |
| ELSTM(2r2l) | 31.2% | 84.2% |
| BLSTM | 33.3% | 85.1% |
| ELSTM(5l2r) | 34.2% | 85.4% |
| ELSTM(5r2l) | 34.0% | 85.2% |
| ELSTM(10l2r) | 34.5% | 85.6% |
| BELSTM(5l2r + 5r2l) | 36.3% | 86.0% |
| BELSTM(10l2r + 10r2l) | 36.5 | 86.2 |

### Hardware Configuration

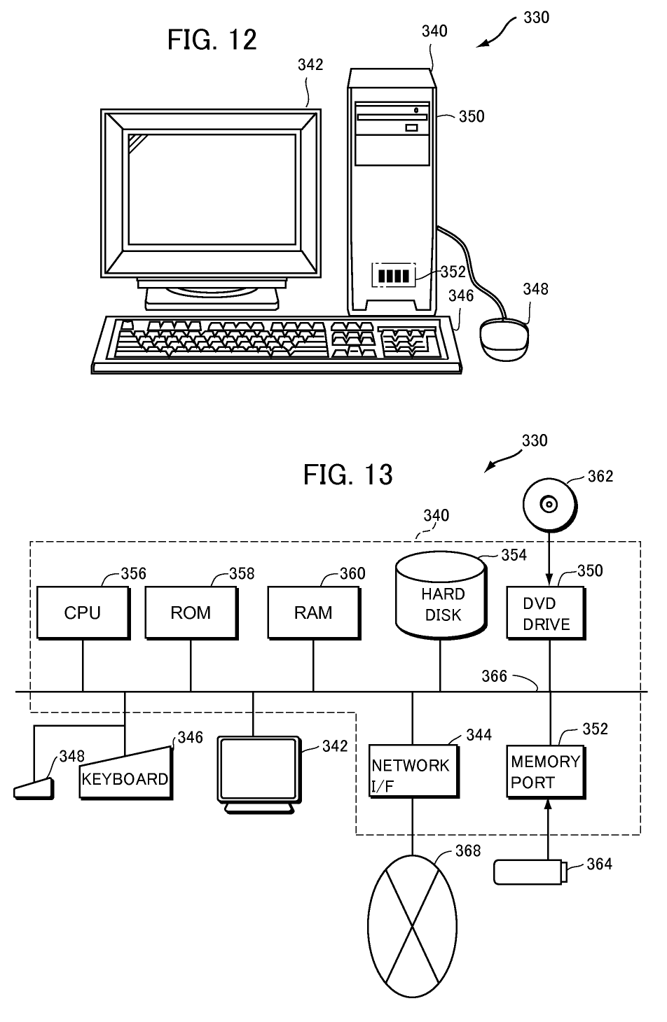

The bidirectional learner 100 and joint search apparatus 140 in accordance with the above-described embodiments can be realized by computer hardware and computer program or programs executed on the computer hardware. FIG. 12 shows an appearance of such a computer system 330, and FIG. 13 shows an internal configuration of computer system 330.

Referring to FIG. 12, computer system 330 includes a computer 340 including a memory port 352 and a DVD (Digital Versatile Disc) drive 350, a keyboard 346, a mouse 348, and a monitor 342.

Referring to FIG. 13, in addition to memory port 352 and DVD drive 350, computer 340 includes: a CPU (Central Processing Unit) 356; a hard disk drive 354, a bus 366 connected to CPU 356, memory port 352 and DVD drive 350; a read only memory (ROM) 358 storing a boot-up program and the like; and a random access memory (RAM) 360, connected to bus 366, for storing program instructions, a system program, the parameters for the neural network, work data and the like. Computer system 330 further includes a network interface (I/F) 344 providing network connection to enable communication with other terminals over network 368. Network 368 may be the Internet.

The computer program or programs causing computer system 330 to function as various functional units of the embodiments above are stored in a DVD 362 or a removable memory 364 loaded to DVD drive 350 or memory port 352, and transferred to hard disk drive 354. Alternatively, the program or programs may be transmitted to computer 340 through a network 368, and stored in hard disk 354. At the time of execution, the program or programs are loaded to RAM 360. Alternatively, the program or programs may be directly loaded to RAM 360 from DVD 362, from removable memory 364, or through the network.

The program or programs include a sequence or sequences of instructions each consisting of a plurality of instructions causing computer 340 to function as various functional units of the system in accordance with the embodiments above. Some of the basic functions necessary to carry out such functions may be provided by the operating system running on computer 340, by a third-party program, or various programming tool kits or program library installed in computer 340. Therefore, the program or programs might not include all functions required to realize the system and method of the present embodiments. The program or programs may include only the instructions that call appropriate functions or appropriate program tools in the programming tool kits provided by the system in a controlled manner to attain a desired result and thereby to realize the functions of the systems described above. The program or programs may include all necessary functions.

In the embodiment shown in FIGS. 5 to 8, the training data, the parameters of each neural network and the like are stored in RAM 360 or hard disk 354. The parameters of sub-networks may also be stored in removable memory 364 such as a USB memory, or they may be transmitted to another computer through a communication medium such as a network.

The operation of computer system 330 executing the computer program is well known. Therefore, details thereof will not be repeated here.

### CONCLUSIONS

When generating the target in a unidirectional process for RNNs, the character level precision falls off with distance from the start of the sequence, and the generation of long sequences therefore becomes a problem. We propose an agreement model on target-bidirectional LSTMs that symmetrize the generative process. The exact search for this agreement model is NP-hard, and therefore we developed two approximate search alternatives, and analyze their behavior empirically, finding them to be near optimal. Extensive experiments showed our approach to be very promising, delivering substantial gains over a range of strong baselines on both machine transliteration and grapheme-to-phoneme conversion. Furthermore, our method has achieved the highest reported accuracy on a standard grapheme-to-phoneme conversion dataset.

In principle it is possible to apply our method to other sequence-to-sequence learning tasks, and in future research we plan to study its application to machine translation.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### REFERENCES

1. Bandanau, D.; Cho, K.; and Bengio, Y. 2014. Neural machine translation by jointly learning to align and translate. CoRR abs/1409.0473.
2. Bisani, M., and Ney, H. 2008. Joint-sequence models for grapheme-to-phoneme conversion. Speech Commun.
3. Finch, A. M., and Sumita, E. 2008. Phrase-based machine transliteration. In Proceedings of IJCNLP.
4. Graves, A. 2013. Generating sequences with recurrent neural networks. CoRR.
5. Hochreiter, S., and Schmidhuber, J. 1997. Long short-term memory. Neural Comput. 9.
6. Jiampojamarn, S.; Cherry, C.; and Kondrak, G. 2008. Joint processing and discriminative training for letter-to-phoneme conversion. In Proceedings of ACL-HLT.

7. Koehn, P.; Hoang, H.; Birch, A.; Callison-Burch, C.; Federico, M.; Bertoldi, N.; Cowan, B.; Shen, W.; Moran, C.; Zens, R.; Dyer, C.; Bojar, O.; Constantin, A.; and Herbst, E. 2007. Moses: open source toolkit for statistical machine translation. In Proceedings of ACL: Demonstrations.
8. Liang, P.; Bouchard-Cote, A.; Klein, D.; and Taskar, B. 2006. An end-to-end discriminative approach to machine translation. In Proceedings of COLING-ACL.
9. Mikolov, T.; Karafiat, M.; Burget, L.; Cernock, J.; and Khudanpur, S. 2010. Recurrent neural network based language model. In Proceedings of INTERSPEECH.
10. Rumelhart, D. E.; Hinton, G. E.; and Williams, R. J. 1986. Parallel distributed processing. chapter Learning Internal Representations by Error Propagation.
11. Sutskever, I.; Vinyals, O.; and Le, Q. V. V. 2014. Sequence to sequence learning with neural networks. In NIPS.
12. Zeiler, M. D. 2012. ADADELTA: an adaptive learning rate method. CoRR.

1. A computer-implemented method of training a first sequence-to-sequence estimation model and a second sequence-to-sequence estimation model, said method comprising:
a step of preparing pairs of sequences in first storage, each pair including a source sequence and a target sequence;
a first step of concatenating a source sequence and a target sequence of each of the pairs of sequences stored in the first storage, thereby generating a first set of concatenated sequences and storing the first set in second storage;
a first step of training the first sequence-to-sequence estimation model utilizing the first set of concatenated sequences stored in the second storage.
a step of permuting a target sequence of each of the pairs of sequences by a first permuting function executed by the computer, thereby producing a permuted target sequence for each of the pairs of sequences;
a second step of concatenating a source sequence of each of the pairs of sequences and the permuted target sequence paired with the source sequence, thereby generating a second set of concatenated sequences and storing the second set in third storage;
a second step of training the second sequence-to-sequence estimation model utilizing the second set of concatenated sequences stored in the third storage.

2. The method in accordance with claim 1, wherein
the permuting function is a function reversing the order of tokens in an input sequence.

3. The method in accordance with claim 2 wherein each of the first and the second sequence-to-sequence estimation models are RNNs.

4. A computer-implemented joint estimation method utilizing the first and the second sequence-to-sequence estimation models trained by the method in accordance with claim 1, comprising the steps of:
receiving an input sequence as an input of the computer;
decoding the input utilizing the first and the second sequence-to-sequence estimation models, thereby producing a prescribed number of best hypotheses from each of the first and the second sequence-to-sequence models;
permuting tokens by a second permuting function executed by the computer, in each of the prescribed number of best hypotheses output from the second sequence-to-sequence estimation model;
re-scoring each of the best hypotheses output from the first sequence-to-sequence estimation model and the best hypothesis with tokens permuted in the permuting step utilizing the first and the second sequence-to-sequence estimation models; and
selecting a hypothesis with the highest score in the re-scoring step as an estimated output corresponding to the input.

5. The joint estimation method in accordance with claim 4, wherein, the second permuting function being an inverse of the first permuting function.

6. The joint estimation method in accordance with claim 5, wherein
the permuting function is a function reversing the order of tokens in an input sequence.

7. The joint estimation method in accordance with claim 6, wherein each of the first and the second sequence-to-sequence estimation models are RNNs.

8. The joint estimation method in accordance with claim 4 wherein
the re-scoring step includes the steps of:
calculating a union set of the best hypotheses output from the first sequence-to-sequence estimation model and the best hypotheses output from the second sequence-to-sequence estimation model with tokens permuted in the permuting step;
computing a first score of each of the hypotheses in the union set utilizing the first sequence-to-sequence estimation model;
computing a second score of each of the hypotheses in the union set utilizing the second sequence-to-sequence estimation model; and
re-scoring each of the hypotheses in the union set by multiplying the first score by the second score.

9. The joint estimation method in accordance with claim 4 wherein
the re-scoring step includes the steps of:
calculating a union set of the best hypotheses output from the first sequence-to-sequence estimation model and the best hypotheses output from the second sequence-to-sequence estimation model with tokens permuted in the permuting step;
generating a set of new hypotheses by concatenating any one of prefixes in the hypotheses in the union set and any one of suffixes in the hypotheses in the union set;
computing a first score of each of the new hypotheses utilizing the first sequence-to-sequence estimation model;
computing a second score of each of the new hypotheses utilizing the second sequence-to-sequence estimation model; and
re-scoring each of the new hypotheses by multiplying the first score by the second score.

10. A computer-implemented joint estimation apparatus utilizing the first and the second sequence-to-sequence estimation models trained by the method in accordance with claim 1, the apparatus comprising:
a data receiving interface connected to the computer, configured to receive an input sequence as an input;
a storage device connected to the computer, for storing the first and the second sequence-to-sequence estimation models; and
a control unit configured to;
decode the input utilizing the first and the second sequence-to-sequence estimation models, thereby producing a prescribed number of best hypotheses from each of the first and the second sequence-to-sequence models;
permute tokens by executing a second permuting function, in each of the prescribed number of best hypotheses output from the second sequence-to-sequence estimation model;
re-score each of the best hypotheses output from the first sequence-to-sequence estimation model and the best hypothesis with tokens permuted in the permuting step utilizing the first and the second sequence-to-sequence estimation models; and
select a hypothesis with the highest score in the re-scoring step as an estimated output corresponding to the input.

11. The joint estimation apparatus in accordance with claim 10, wherein, the second permuting function being an inverse of the first permuting function.

12. The joint estimation method in accordance with claim 11, wherein
the permuting function is a function reversing the order of tokens in an input sequence.

13. The joint estimation apparatus in accordance with claim 12, wherein each of the first and the second sequence-to-sequence estimation models are RNNs.

14. The joint estimation apparatus in accordance with claim 10 wherein
in re-scoring, the control unit is configured to
calculate a union set of the best hypotheses output from the first sequence-to-sequence estimation model and the best hypotheses output from the second sequence-to-sequence estimation model with tokens permuted;
compute a first score of each of the hypotheses in the union set utilizing the first sequence-to-sequence estimation model;
compute a second score of each of the hypotheses in the union set utilizing the second sequence-to-sequence estimation model; and
re-score each of the hypotheses in the union set by multiplying the first score by the second score.

15. The joint estimation apparatus in accordance with claim 10 wherein
in rescoring, the control unit is configured to
calculate a union set of the best hypotheses output from the first sequence-to-sequence estimation model and the best hypotheses output from the second sequence-to-sequence estimation model with tokens permuted;
generate a set of new hypotheses by concatenating any one of prefixes in the hypotheses in the union set and any on of suffixes in the hypotheses in the union set;
compute a first score of each of the new hypotheses utilizing the first sequence-to-sequence estimation model;
compute a second score of each of the new hypotheses utilizing the second sequence-to-sequence estimation model; and
re-score each of the new hypotheses by multiplying the first score by the second score.
